(19) United States
(12) Patent Application Publication
(10) Pub. No.: US 2007/0250934 A1
(43) Pub. Date: Oct. 25, 2007

(54) Method for Preventing Input Information from Exposing to Observers

(76) Inventor: Seung-Bae Park, Gwangju (KR)

Correspondence Address: ROBERT E. BUSHNELL, 1522 K STREET NW, SUITE 300, WASHINGTON, DC, 20005-1202, US

(21) Appl. No.: 11/628,048

(22) PCT Filed: May 31, 2005
(86) PCT No.: PCT/KR05/01619

§ 371 Date: Feb. 1, 2007

(30) Foreign Application Priority Data
May 31, 2004 (KR) 10-2004-0039209

(51) Int. Cl. G06F 17/00

(52) U.S. Cl. 726/26

(57) ABSTRACT

A method for preventing input information from exposing to observers is disclosed. The information input method according to the present invention provides an action symbol group, a non-action symbol group and a control tool group through a secret information input unit. Users input their desirable information to the action symbol group, as one of movement operation, disappear operation and symbol value increment (decrement) operation is conducted. Although observers watch information input processes, since the information input method of the present invention does not allow the observers to recognize the inputted information, it can basically prevent input information from exposing to observers.

### TECHNICAL FIELD

The present invention relates to an information inputting method, and more particularly to a new information inputting method for preventing the input information from exposing to observers.

### BACKGROUND ART

In the modern information-oriented society, various information devices are provided in various shapes. For example, there are provided numerous information devices such as personal computers, mobile phones, automatic teller machines, automatic ticket issuers, access control systems. Such information devices process information independently or in connection with a network.

In such an information-oriented society, protection of information is a very important subject, and unintended information exposure causes serious problems. As a representative case, exposure of a secret number of a back account always raises problems. Information exposure is generated in various routes, and information is primarily exposed to an observer while the information is being input.

Most information devices are equipped with an input device for input of information from users. As a representative input device, there are keypad and keyboard, which are a kind of key input device provided with various input keys. In other case, a virtual keyboard that displays information graphically on a display combined with a touch screen is provided.

For example, the automatic teller machine is provided with a keypad input device or a virtual keypad device using a touch screen in order to receive information from users. A user uses the provided input device to input information such as a secret number and a transfer account. During such an information input procedure, the input information is apt to be easily exposed to observers.

Such information exposure to observers during the information input procedure comes from an input device and an information inputting method using the input device. The key input device has a fixed unit information input to a unit input key, and this fixed unit information is displayed on the corresponding input key. Thus, if a user pushes or selects ‘an input key A’, an observer may recognizes based on such behavior that the input information is ‘A’.

The information input device using a key input manner and the information inputting method using the input device are widely used since it allows convenient input of information and inexpensive installation costs. However, they have serious problems that input information is easily exposed to observers.

### DISCLOSURE

### Technical Problem

The present invention is designed to solve the problems of the prior arts, and therefore an object of the invention is to provide an information inputting method that prevents observers from recognizing input information though the observers see the information input procedure.

### TECHNICAL SOLUTION

In order to accomplish the above object, the present invention provides an information inputting method for inputting information (X; X=X₁X₂. Xₙ, XᵢεY (1≦i≦n)) by using an information device equipped with an information input unit, which includes the steps of: providing an action symbol group, a non-action symbol group and a control tool group to the information input unit; and matching a specific symbol (decided by a user) in the action symbol group with a unit input information (Xᵢ) by taking a movement operation to the action symbol group using the control tool group by the user.

In this embodiment, the information inputting method may further include the step of informing that the unit input information (Xᵢ) is completely input by using the control tool group.

In this embodiment, the user preferably matches the specific symbol (decided by the user) with a predetermined symbol previously defined in the non-action symbol group when a final unit input information (Xₙ) is input.

In another aspect of the invention, there is also provided an information inputting method for inputting information (X; X=X₁X₂ . . . Xₙ, XᵢεY (1≦i≦n)) by using an information device equipped with an information input unit, which includes the steps of: providing an action symbol group, a non-action symbol group and a control tool group to the information input unit; displaying symbols in the action symbol group; conducting an operation for disappearing the symbols displayed in the action symbol group; and selecting a symbol of the non-action symbol group that is corresponding to a position where a system corresponding to the unit input information (Xᵢ) among the symbols displayed in the action symbol group.

In this embodiment, the operation for disappearing the symbols displayed in the action symbol group is preferably automatically conducted a predetermined time after the symbols are displayed.

In this embodiment, the operation for disappearing the symbols displayed in the action symbol group is preferably selectively conducted on the receipt of instruction from the user using the control tool group.

In this embodiment, in case that the user selects a symbol in the non-action symbol group corresponding to a position where (Xᵢ) is displayed in order to input a unit input information (Xᵢ), symbols of the action symbol group including unit input information (Xᵢ₊₁, 1≦i≦n−1) are preferably displayed in other regions except the position where Xᵢ is displayed, and, in case that the selection of the user is released, the operation for disappearing the symbols displayed in the action symbol group is preferably conducted.

In still another aspect of the invention, there is also provided an information inputting method for inputting information (X; X=X₁X₂ . . . Xₙ, X₁εY (1≦i≦n)) by using an information device equipped with an information input unit, which includes the step of: providing an action symbol group, a non-action symbol group and a control tool group to the information input unit; and a user increasing (or, decreasing) values of symbols displayed in the action symbol group by using the control tool group so that a value of a group in the action symbol group corresponding to a specific symbol (decided by the user) in the non-action symbol group is coincided with a value of a symbol corresponding to a unit input information (Xᵢ).

In this embodiment, the information inputting method may further include the step of informing with the use of the control tool group that the unit input information (Xᵢ) is completely input.

In this embodiment, in the step of inputting a final unit input information (Xₙ), the user preferably makes the symbol of the action symbol group corresponding to the specific symbol (decided by the user) in the non-action symbol group be a value of a predetermined value symbol.

In this embodiment, in the step of increasing (or, decreasing) values of the symbols displayed in the action symbol group, increment amounts of the symbols in the action symbol group are preferably all identical to each other, or at least one symbol preferably has a different increment (or, decrement) amount.

### ADVANTAGEOUS EFFECTS

The present invention solves problems of the information inputting devices using a key input manner commonly used until now and the information inputting methods using such devices, for example a critical problem that input information is easily exposed to observers. The information inputting method of the present invention gives effects of basically preventing the problem that input information is flowed out to observers during an information inputting procedure since any observer may not recognize the input information though he/she observes the information inputting procedure.

### DESCRIPTION OF DRAWINGS

FIG. 1 is a diagram illustrating an information inputting method according to a first embodiment of the present invention;

FIG. 2 is a diagram illustrating an information inputting method according to a second embodiment of the present invention;

FIGS. 3 and 4 are diagrams illustrating an information inputting method according to modifications of the present invention;

FIG. 5 is a flowchart illustrating an information input procedure according to the first and second embodiments of the present invention;

FIG. 6 is a diagram illustrating an information inputting method according to a third embodiment of the present invention;

FIG. 7 is a flowchart illustrating an information input procedure according to the third embodiment of the present invention;

FIG. 8 is a diagram illustrating symbols used in the information inputting method of the present invention;

FIG. 9 is an illustration showing an action symbol group P, a non-action symbol group Q and a control tool group R;

FIG. 10 is an illustration showing the case that action for operation is considered identical;

FIG. 11 is an illustration showing the case that a method for inputting secret information X is identical;

FIG. 12 is an illustration showing symbols that may be used in a password system of the present invention;

FIG. 13 is an illustration showing how a symbol is seen in the real world;

FIG. 14 is an illustration showing the case that a group of at least two symbols is considered identical;

FIG. 15 is an illustration for explaining the number of symbols pertaining to the action symbol group P, the non-action symbol group Q and the control tool group R;

FIG. 16 shows one-to-one relations between symbols in a secret information input unit and integers;

FIG. 17 is an illustration showing the case that the numbers of action symbols (|P|) are identical and the numbers of non-action symbols (|Q|) are different;

FIG. 18 is an illustration for exhibiting the intended restoring extraction; and

FIG. 19 is an illustration showing the case that every ten symbols are extracted in the non-action symbol group P without restoration.

### BEST MODE

Hereinafter, preferred embodiments of the present invention will be described in detail with reference to the accompanying drawings. The embodiments of the present invention may be modified in various ways, and the scope of the invention should not be interpreted to be limited to the embodiments described later. These embodiments are provided for the purpose of clearer illustration only to those skilled in the art.

Hereinafter, an information inputting method according to an embodiment of the present invention is described based on a password system as an example. This password system may be provided with a keyboard input device with various input keys and a pointing device as a user interface, and also provided with a display for displaying information. These configurations may include those of a general personal computer system, for example. The display may additionally have a touch screen so as to allow image acquisition. Here, the user interface for information input may have any configuration if it may realize the information inputting method of the present invention. Thus, it should be noted that such configurations may be added, removed or modified by those skilled in the art as required.

1. Information Inputting Methods for Preventing Input Information from Exposing

Secret information means as information that should not be exposed to other persons based on the general concepts. For example, the secret information may be a password and a secret number. Hereinafter, the secret number is defined as X=X₁X₂ . . . Xₙ, where XᵢεY (1≦i≦n). Y is a group of symbols that express X.

1. Method for Inputting Secret Information by means of Symbol Matching

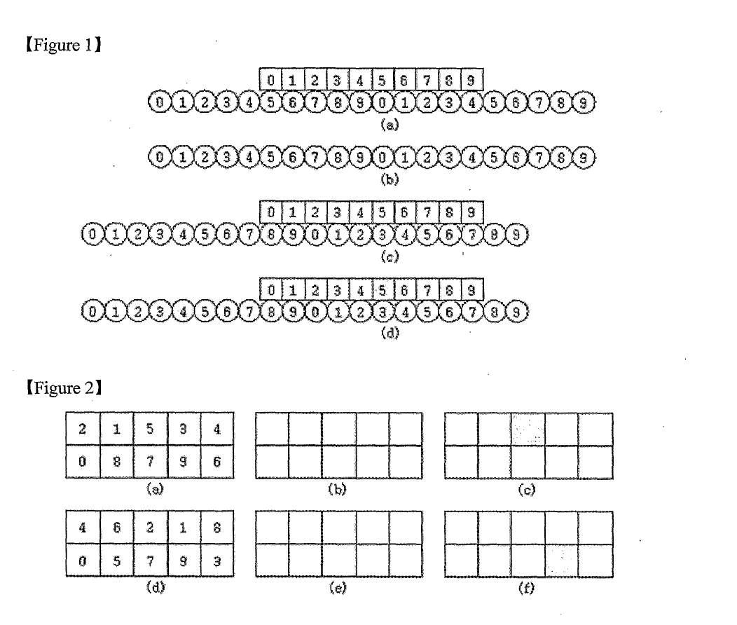

FIG. 1 is a diagram illustrating the information inputting method according to the first embodiment of the present invention.

For inputting X, the password system displays user interface as shown in (a) of FIG. 1 on a screen of a display. In order to input Xᵢ, A user selects any one of symbols in a lower row, shown in (b) of FIG. 1, and then matches the selected symbol with a symbol in an upper row in correspondence to Xᵢ.

For example, it is assumed that X₁=5 and a user decides the symbol \textcircled{3} in mind in (b) of FIG. 1. Then, the user takes operation to move symbols in (b) of FIG. 1 to the left three times from the state of (a) of FIG. 1 in order to input X₁=5. In order to move the symbols in (b) of FIG. 1 to the left, the user may use a left arrow key provided on a keyboard device. (c) of FIG. 1 shows the symbols in (b) of FIG. 1 existing in (a) of FIG. 1 are moved to the left three times. The user informs the system that X₁=5 is completely input. As an example of informing the system that X₁=5 is completely input, the user may push an enter key. (d) of FIG. 1 shows that X₁=5 is completely input since [symbol] is positioned in the same row as \textcircled{3}.

As mentioned above, the information inputting method of the first embodiment of the present invention includes the steps of: a user deciding any symbol in mind for matching in order to input X, taking operation to match any symbol decided by the user with Xᵢ by moving the symbols, and informing that Xᵢ is completely input, which are repeatedly executed, and then finally informing that the system that X is completely input.

The step for a user to inform the system that Xᵢ is completely input may be implemented in another way. For example, the user may change a movement direction of symbols so as to express that Xᵢ is completely input. In addition, the step of finally informing that the system that X is completely input may be excluded. For example, in case that the system already knows the length of X, it may not be needed to inform that the system that X is completely input.

In the method for inputting secret information as mentioned above, there may be various modifications for symbol arranging ways, symbol displaying patterns and symbol kinds. If symbols are in order, it is not preferred that the symbols are arranged subsequently. That is to say, it is preferable that each symbol is extracted and arranged at random. In other case, it is also possible that several symbols are extracted together and then arranged. Or, standard and pattern of symbols matched may also have various modifications. Such modifications are apparent to those skilled in the art based on the spirit of the invention described here.

2. Method for Inputting Secret Information after Symbols Disappears

FIG. 2 is a diagram illustrating the information inputting method according to the second embodiment of the present invention.

In order to input X, the password system displays user interface as shown in (a) of FIG. 2 on a screen of the display. In the user interface shown in (a) of FIG. 2, number symbols expressed in a symbol □ disappear before Xᵢ is input and displayed as shown in (b) of FIG. 2. In this state, a user selects a symbol □ at a position where Xᵢ is displayed so as to input Xᵢ.

For example, it is assumed that X=X₁X₂=59. In (a) of FIG. 2, a user confirms (or, decides) a symbol (or, place) on which X₁=5 is expressed, in mind. (c) of FIG. 2 shows a place on which X₁=5 is expressed. The user takes operation to disappear numbers in (a) of FIG. 2. (b) of FIG. 2 shows a state after numbers disappear in (a) of FIG. 2. The user selects in the state of (b) of FIG. 2 the place confirmed in (a) of FIG. 2 so as to input X₁=5 and inform that X₁ is completely input.

The system then displays symbols in the symbol □ as shown in (d) of FIG. 2 so that X₂ is input. At this time, the symbols expressed in the symbol [ ] are preferably arranged differently from (a) of FIG. 2.

In (d) of FIG. 2, the user confirms (or, decides) a symbol (or, place) on which X₂=9 is expressed, in mind. (f) of FIG. 2 shows a place on which X₂=9 is expressed. The user takes operation to disappear numbers in (d) of FIG. 2. (e) of FIG. 2 shows a state after numbers disappear in (d) of FIG. 2. The user selects in the state of (e) of FIG. 2 the place confirmed in (d) of FIG. 2 so as to input X₂=9 and inform that X₂ is completely input.

The information inputting method according to the second embodiment of the present invention includes the steps of: a user deciding a symbol on which Xᵢ is positioned among the displayed symbols so as to input X, taking operation to disappear the symbols, selects a symbol □ at the place on which Xᵢ is positioned so as to input Xᵢ and inform that Xᵢ is completely input, which are repeatedly executed. And then, the method executes the step of finally informing that X is completely input.

The step of finally informing that the system that X is completely input may be excluded. For example, in case that the system already knows the length of X, it may not be needed to inform that the system that X is completely input.

The operation to disappear or display number symbols in the user interface may be conducted manually by means of user selection or automatically by control of the system. In the method for inputting secret information as mentioned above, there may be various modifications for symbol arranging ways, symbol displaying patterns and symbol kinds. If symbols are in order, it is not preferred that the symbols are arranged subsequently. That is to say, it is preferable that each symbol is extracted and arranged at random. In other case, it is also possible that several symbols are extracted together and then arranged. Or, standard and pattern of symbols matched may also have various modifications. Such modifications are apparent to those skilled in the art based on the spirit of the invention described here.

In the method for inputting X according to the second embodiment of the present invention, X is input in such a way that a plurality of symbols are displayed and then disappears, and then a user selects a symbol □ at a position where Xᵢ to be input is appeared. Thus, though an observer observes the procedure of inputting X by a user, the observer may substantially not know Xᵢ since Xᵢ is input after the symbols disappear. In order to know Xᵢ, the observer should remember positions where all symbols are displayed, but it is substantially impossible.

Now, in relation to the method for inputting secret information according to the second embodiment of the present invention, an improved method for inputting secret information with a shorter time in a more convenient way is described.

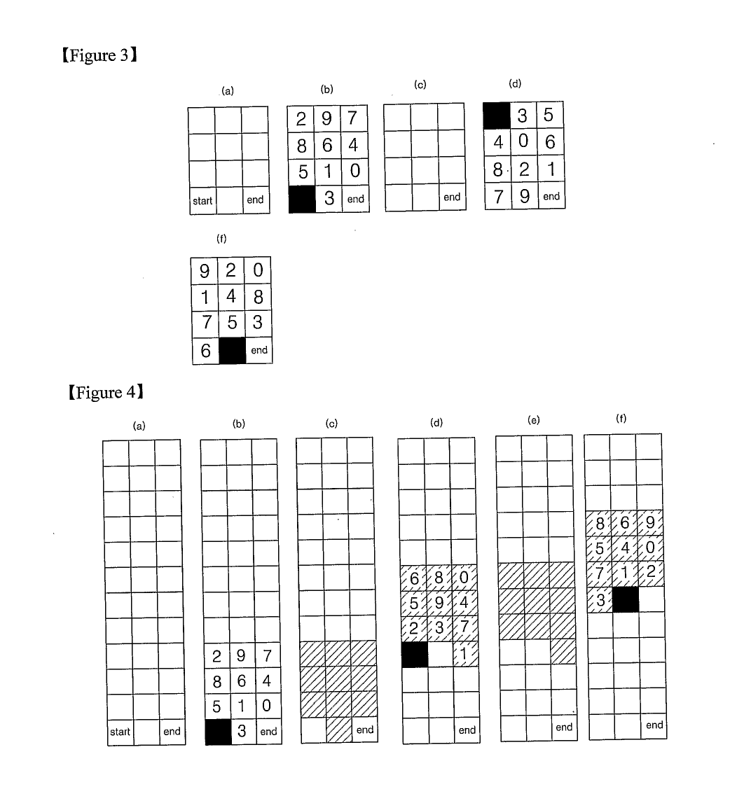

FIGS. 3 and 4 are diagrams illustrating the information inputting method according to modifications of the second embodiment of the present invention.

In order to input X, the password system displays user interface as shown in (a) of FIG. 3 on a screen of the display. This user interface displays 12 symbols □ in total, including ‘start’, ‘end’, and blanks.

The information inputting procedure is initiated by selecting the symbol □ displaying ‘start’ on the user interface shown in (a) of FIG. 3. If the symbol □ showing ‘start’ is selected, number symbols are arranged at random and displayed in the blank symbols □ as shown in (b) of FIG. 3. At this time, if the selection of the ‘start’ symbol is released, the displayed symbols disappear as shown in (c) of FIG. 3. In this state, a user selects a place where a number to be input is displayed so as to input Xᵢ.

For example, it is assumed that X₁X₂=29. Then, a user recognizes a position of 2 in the state of (b) of FIG. 3, and selects the position of 2 in the state of (c) of FIG. 3 so as to input 2. At this time, 10 symbols including 9 as shown in (d) of FIG. 3 are arranged at random and displayed in residual regions other than the selected one. In this state, the number symbols is continuously displayed until the user releases the selection.

If the user releases the selection, the number symbols displayed in (d) of FIG. 3 disappear and becomes like (c) of FIG. 3. The user selects the position where 9 appeared in (d) of FIG. 3, and inputs 9 therein. At this time, symbols are arranged and displayed at random as shown in (e) of FIG. 3. These procedures are repeated to input X.

If a user selects a position where Xᵢ appeared in order to input Xᵢ as mentioned above, the operation to display symbols including Xᵢ₊₁ in regions except the position where Xᵢ appeared is conducted (1≦i≦n−1). In addition, if the user releases the selection of the position where Xᵢ appeared, operation to make the symbols including Xᵢ₊₁ disappeared is conducted (1≦i≦n−1). Thus, a user may input X more rapidly.

In this embodiment, if a user physically pushes a selection region directly by a finger, the displayed symbols may be hidden by the hand of the user. Thus, as shown in FIG. 4, a plurality of regions displaying symbols are arranged vertically long so that symbols are displayed from the lowest row, but above a horizontal row selected by the user.

For example, it is assumed that X₁X₂=29. If a user selects ‘start’ in (a) of FIG. 4, symbols are arranged and displayed in four rows at random as shown in (b) of FIG. 4. If the selection is released, the symbols disappear as shown in (c) of FIG. 4. At this time, the regions having displayed symbols may be displayed distinguishably from other regions. A user recognizes a position where 2 is shown in (b) of FIG. 4, and then selects the position where 2 was shown in (b) of FIG. 4, in the state of (c) of FIG. 4 to input 2. At this time, ten symbols including 9 are arranged and displayed at random above a horizontal row where the selected symbol was positioned as shown in (d) of FIG. 4. In this state, the number symbols keep displayed until the user releases the selection.

If the user releases the selection, the number symbols shown in (d) of FIG. 4 are disappeared like (e) of FIG. 4. The user selects the position where 9 was shown in order to input 9, and at this time symbols are arranged and displayed at random as shown in (f) of FIG. 4. Such procedure is repeated until X is input. If X is completely input, the user selects ‘end’ to inform the system that X is completely input.

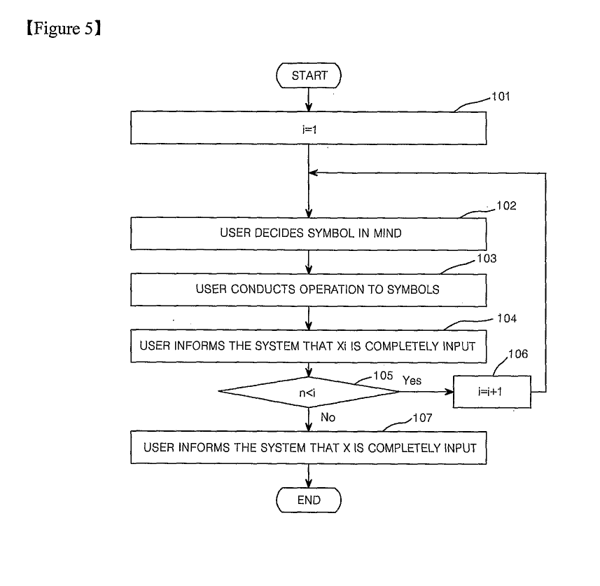

FIG. 5 is a flowchart illustrating the information inputting procedure according to the first and second embodiments of the present invention. The procedure repeatedly executes the steps 102 to 106 of: a user deciding in mind a symbol 102, taking operation to the symbol 103, and informing the system that Xᵢ is completely input 104, and then a user finally informs the system that X is completely input 107. As mentioned above, the step of finally informs the system that X is completely input 107 may be excluded on occasions.

3. Method for Inputting Secret Information by Increment (Decrement) Symbol Value at Selected Position

FIG. 6 is a diagram illustrating the information inputting method according to the third embodiment of the present invention.

In the third embodiment of the present invention, for input of X, the password system displays user interface as shown in (a) of FIG. 6 on a screen of the display. In the user interface shown in (a) of FIG. 6, a user selects a symbol □ at any position. Xᵢ is input by increasing or decreasing the number symbol expressed in the symbol □ at the selected position.

For example, it is assumed that X=X₁X₂=59 and Y={0, 1, 2, . . . , 9}. Then, the user decides in mind a symbol □at any position in the state of (a) of FIG. 6. In this state, it is assumed that the user decides in mind a symbol □ including a number 3. (b) of FIG. 6 shows the symbol □ at the position that the user decides in mind. The user takes operation for increasing numbers in (a) of FIG. 6 by 1 twice so that the number 3 in the symbol □ decided in mind of the user becomes 5.

(c) of FIG. 6 shows that all numbers in (a) of FIG. 6 are increased by 2. It is found that the number in the symbol decided in the mind of the user is changed from 3 to X₁=5. Here, in order to change the number 3 in the symbol decided by the user into 5, the numbers in (a) of FIG. 6 are increased at the same time by 1 twice, which is considered as one operation. In addition, when the user makes the numbers in (a) of FIG. 6 increased by 1 at the same time, the largest number 9 in Y becomes 0, the smallest number, by the increment so as to prevent 9 from being 10 that is not considered as an element in Y. The user informs the system that X₁=5 is input. In order to display X₂=9 in the symbol decided in (a) of FIG. 6, the user increases the numbers in (c) of FIG. 6 by 1 at the same time four times. (d) of FIG. 6 shows that X₂=9 is shown in the symbol selected by the user in (a) of FIG. 6. The user informs the system that X₂=9 is input. Increasing or decreasing values of the symbols may be realized using upward or downward arrow keys on the keyboard device, and informing the completion of input may be realized using the enter key on the keyboard device.

After Xᵢ is input, symbols displayed on the user interface are preferably arranged at random again. In other case, increment amount of each symbol may be differently set. For example, a value of a symbol at any position may be blank at least one time without being increased. In this case, since a symbol value is subsequently increased and then displayed blank at one position, the symbol at the blank position is resultantly not increased when symbols at other positions are increased by unit increment amount, 1. Thus, increment amounts of each symbol may be differently set by displaying any position blank.

In such a secret information inputting method, there may be various modifications for symbol arranging ways, symbol displaying patterns and symbol kinds. If symbols are in order, it is not preferred that the symbols are arranged subsequently. That is to say, it is preferable that each symbol is extracted and arranged at random. In other case, it is also possible that several symbols are extracted together and then arranged. Or, standard and pattern of symbols matched may also have various modifications. Such modifications are apparent to those skilled in the art based on the spirit of the invention described here.

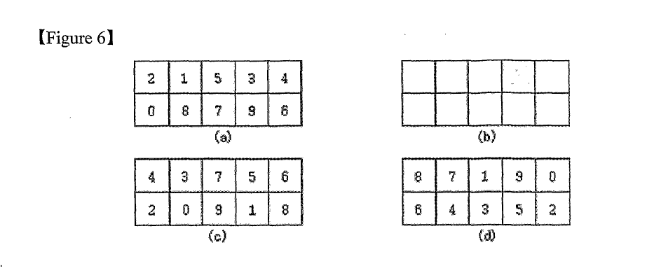

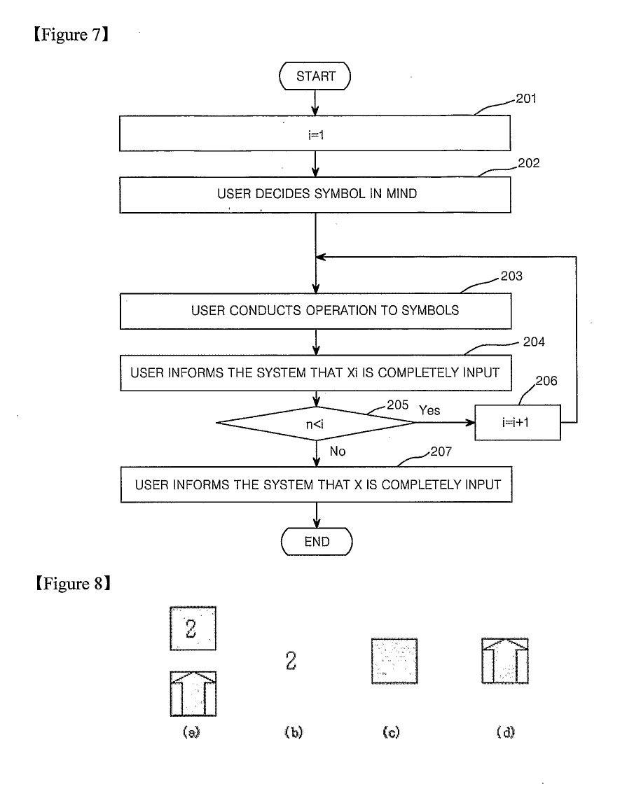

FIG. 7 is a flowchart illustrating the information inputting procedure according to the third embodiment of the present invention. A user executes the step 202 of deciding in mind a symbol once, and then repeatedly executes the step 203 of taking operation to the symbol and the step 204 of informing the system that Xᵢ is completely input, so as to input X. And then, the user informs the system that X is completely input 207. As mentioned above, the step of informing the system that Xᵢ is completely input may be excluded on occasions.

The information inputting methods according to the first to third embodiments described above may be dependent on any equipments or systems applied thereto, as mentioned above. Any change derived from such circumstances may not be considered to depart from the spirit of the invention.

II. Secret Information Input Unit and Operation of Symbol

1. Definition of Symbols

In the password system adopting the information inputting method of the present invention, secret information is input using a secret information input unit including a plurality of symbols.

For example, as described above as a user interface in the above embodiments, a graphic user interface may be displayed on a screen of the display, and then it may operate in response to input via a keyboard device or a pointing device. In case of being equipped with a touch screen, the interface may be operated in response to input via the touch screen.

As mentioned above, the secret information input unit includes hardware and software configurations required for devices or systems adopting the information inputting method of the present invention. Such configurations would be apparent to those skilled in the art, based on the spirit of the present invention.

Symbols provided to the secret information inputting unit basically includes symbols responding to operation, symbols not responding to operation, and symbols used for operation.

Referring to FIG. 8, for example, it is assumed that X₁=5 and a user input X₁=5 by increasing 2 in (a) of FIG. 8 by 3. In addition, it is also assumed that, if the user pushes an arrow button in (d) of FIG. 8 once in the state of (a) of FIG. 8, the number shown in (a) of FIG. 8 is increased by 1 every time. In this case, number symbols in (b) of FIG. 8 are symbols responding to operation, symbols □ in (c) of FIG. 8 are symbols not responding to operation, and (d) of FIG. 8 shows symbols used for operation.

As for the symbols displayed in the secret information input unit, the group of symbols responding to operation is called an action symbol group, marked as P, and the group of symbols not responding to operation is called a non-action symbol group, marked as Q. In addition, the group of symbols used for operation is called a control tool group, marked as R.

For example, it is assumed that X₁X₂=59. In addition, it is assumed that, in (a) of FIG. 9, a user decides in mind a symbol \textcircled{3} and then the user moves the symbol group so that symbols [symbol] and [symbol] are positioned in the same row, so as to input X₁=5 and X₂=9. In addition, it is assumed that the user uses right and left arrow symbols in (b) of FIG. 9 so as to move the symbol groups in (c) of FIG. 9 to the right or left. Then, (b) of FIG. 9 shows R, (c) of FIG. 9 shows P, and (d) of FIG. 9 shows Q.

2. Definition of Operation

The information inputting method of the present invention inputs X by conducting operation to the symbols displayed in the secret information input unit as in the first to third embodiments described above. The operation makes symbols in P disappeared or moved, or increases values of the symbols in P. The operation making symbols in P disappeared at the same time is marked as A, the operation making symbols in P moved is marked as B, and the operation increasing values of symbols in P is marked as C.

3. Display of Xₙ and Inputting Method

It may be preferable that Xₙ finally input in the information inputting method of the present invention is a symbol previously agreed between the user and the system.

For example, in case of displaying X₁=5 in a symbol selected by the user in mind by conducting C to P in the state of (a) of FIG. 6, the system cannot recognize which symbol is selected by the user. In this case, the user may input X₁X₂ . . . Xₙ₋₁ and then input the symbol Xₙ previously agreed with the system so as to inform the system which symbol was selected in mind in the state of (a) of FIG. 6. Here, the symbol previously agreed between the user and the system is considered as Xₙ since it is input while the secret information is input.

In case of conducting A to P, P preferably includes all symbols of Y. In addition, in case of conducting B to P, Q preferably includes all elements of Y. In addition, when C is conducted to P, it may be preferable that symbols in P are increased by 1 or repeat increment by 1 if elements in Y may be arranged in ascending power, while symbols in P are increased in an order set by the system or repeat increment if arrangement of elements in P is not appropriate.

In case that Xₙ is a symbol previously agreed between the system and the user, the system basically determines a point of showing Xₙ, a value of Xₙ and a position of Xₙ, but they may be shown as preferred.

For example, in case that the user inputs X by conducting C to P, it would be preferable that the system does not consider Xₙ as an element of Y until the user inputs X₁X₂ . . . Xₙ₋₁, and the system considers Xₙ as an element of Y at the point that the user inputs Xₙ. For example, in case that the user inputs X by conducting C to P, it may be preferable that a value of Xₙ is the largest value among elements in Y if symbols in P may be arranged. For example, in case that the user inputs X by conducting B to P and symbols in P are arranged in a row in the secret information input unit and shown in the arranged order, it may be preferable that Xₙ is shown in the right in comparison with other symbols in P.

4. Examples Considered to be the Same Operation

Now, examples considered to be the same operation as them described in the above embodiments are explained. As described later, there may be many examples that may be considered as the same operation, so operations based on the spirit of the present invention should not be considered as different operations though they are not handled here.

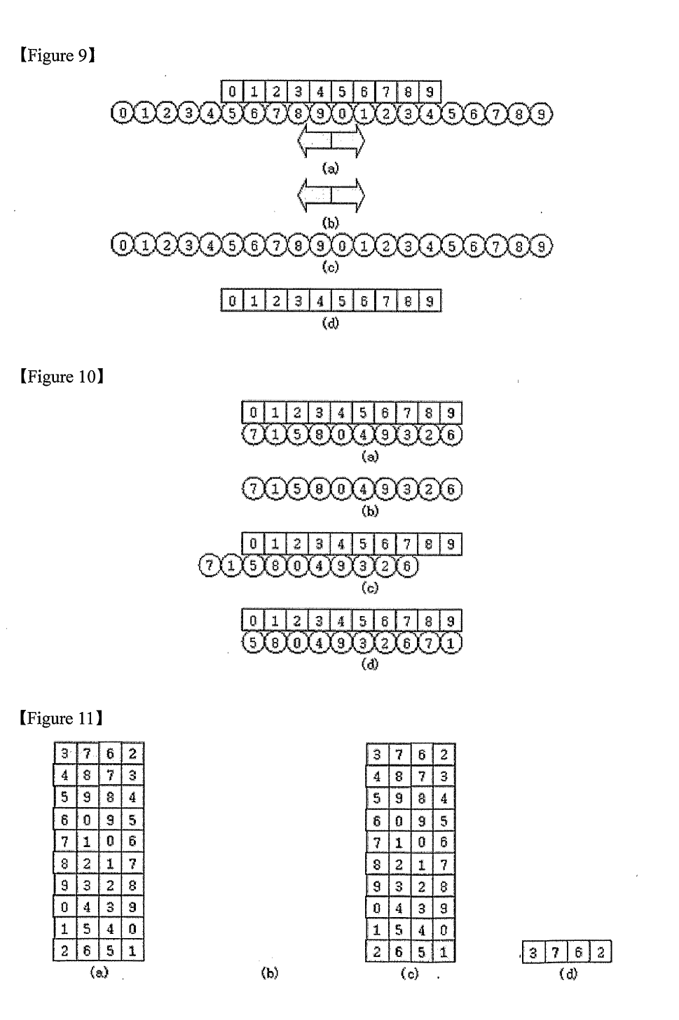

For example, X₁=5, (a) of FIG. 10 shows P and Q, and (b) of FIG. 10 shows P of (a) of FIG. 10. In addition, it is assumed that a user decides a symbol \textcircled{3} in P in mind, and conducts B to P so that the symbol \textcircled{3} in P and a symbol [symbol] in Q are positioned in the same row, thereby inputting X₁=5.

Both (c) and (d) of FIG. 10 show the state that X₁=5 is input by conducting B to P. Here, (c) of FIG. 10 and (d) of FIG. 10 are different from each other only in the point that symbols of P out of a left border of Q in (c) of FIG. 10 becomes the rightmost symbols of P in (d) of FIG. 10, and except this fact both (c) and (d) of FIG. 10 are the same operation since they input X₁=5 by taking B to P of (a) of FIG. 10.

As another example, it is assumed that X₁=5, a user decides one row in mind one row in the state of (a) of FIG. 11, and then the user inputs X₁=5 by moving P of (b) of FIG. 11 downward from the state of (a) of FIG. 11 so that the row decided in the mine is overlapped with X₁=5. (c) of FIG. 11 shows that the user decides the third row in mind in the state of (a) of FIG. 11 and then inputs X₁=5. Here, moving (b) of FIG. 11 down by one step from (a) of FIG. 11 is the same operation as the operation taking C to P since it considers the first row of (a) of FIG. 11 as P and Q and considers numbers in the first row as symbols in P.

5. Use of Symbols

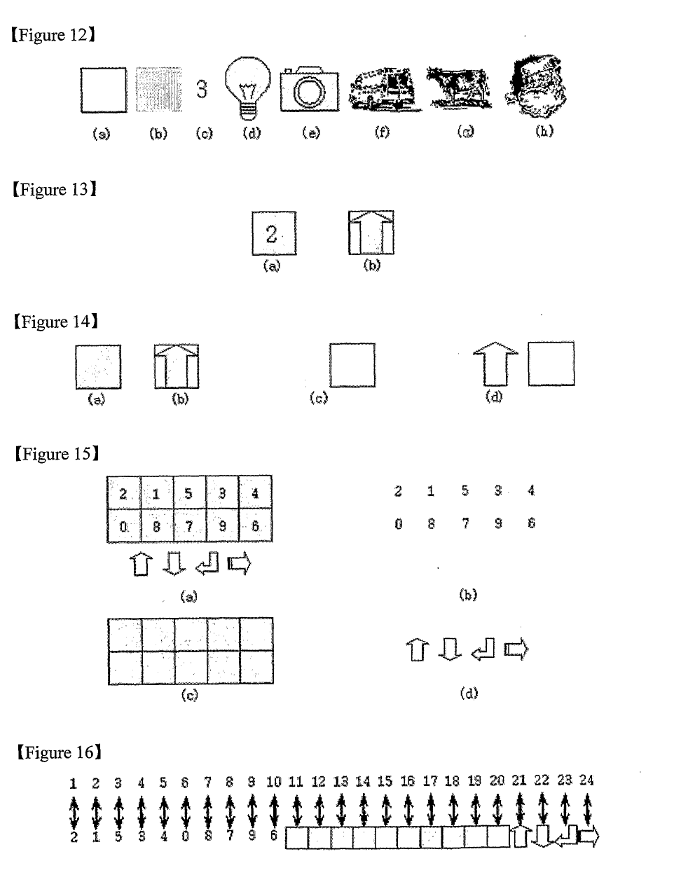

All objects capable of being seen by the naked eye may be used as the symbols in the secret information input unit. FIG. 12 shows examples of symbols usable in the password system of the present invention. Such symbols appears as a result of hardware modules or software modules in the real world.

For example, it is assumed that X₁=5, (b) of FIG. 13 is a symbol pertaining to R, and a user inputs X₁=5 by increasing the symbol 2 in (a) of FIG. 13 by 3. Then, the symbol in (b) of FIG. 13 pertaining to R is shown as a result of a hardware module or a software module (or, program) in the real world.

It is assumed that a symbol of (a) of FIG. 14 pertains to Q and a symbol of (b) of FIG. 14 pertains to R. Then, the symbol of (a) of FIG. 14 considers two overlapped symbols of (c) of FIG. 14 as one symbol, and the symbol of (b) of FIG. 14 considers three overlapped symbols of (d) of FIG. 14 as one symbol. In case that two or more symbols are bound to be handled as one symbol with respect to their functions, the bound symbols are considered as one symbol.

In the password system of the present invention, a part related to symbols may be dependent on the system. It means that the part related to symbols does not depart from the scope of the password system of the present invention though it is changed.

For example, in the password system of the present invention, the determination whether any symbol pertains to P or Q is dependent on the system. A symbol in P and a symbol in Q may be overlapped or not in the secret information input unit. In addition, the determination whether any symbol is an element of Y is dependent on the system. Here, “dependent on the system” involves the meaning that a system developer determines in consideration of users.

6. Features of Symbols

The number of symbols in the action symbol group P is marked as |P|, the number of symbols in the non-action symbol group Q is marked as |Q|, and the number of symbols in the control tool group R is marked as |R|. For example, it is assumed that the secret information input unit is as shown in (a) of FIG. 15. In addition, it is assumed that P is a group of systems pertaining to (b) of FIG. 15, Q is a group of symbols pertaining to (c) of FIG. 15, and R is a group of symbols pertaining to (d) of FIG. 15. Then, |P|=10, |Q|=10, and |R|=4.

It is assumed that φ and φ are two symbols different from each other, pertaining to P or Q or R. Then, two different integers may be corresponded to φ and φ. Here, though φ and φ are shown in the same pattern in the secret information input unit, they are considered as different symbols if they appear in different positions. In addition, if φ is shown above φ in the secret information input unit, φ is corresponding to a positive integer smaller than a positive integer corresponding to φ. Moreover, in case that φ and φ are in the same phase in the secret information input unit (it means y-axis coordinates of φ and φ are identical when the secret information input unit is considered as one plane), φ is corresponding to a positive integer smaller than a positive integer corresponding to φ if φ is positioned left based on φ. In addition, it is assumed that symbols in P are corresponding to integers from 1 to |P|, symbols in Q are corresponding to integers from |P|+1 to |P|+|Q|, and symbols in R are corresponding to integers from |P|+|Q|+1 to |P|+|Q|+|R|. Then, the symbols having the number of |P|+|Q|+|R| in the secret information input unit may be corresponding to integers from 1 to |P|+|Q|+|R|, arranged in serial, in one-to-one relation.

For example, 24 symbols (|P|+|Q|+|R|=24) in (a) of FIG. 15 may be corresponding to integers from 1 to 24 in one-to-one relation as shown in FIG. 16. As mentioned above, if symbols in P, Q and R may be corresponding to integers from 1 to |P|+|Q|+|R| in one-to-one relation regardless of the number of symbols in P, Q and R, method for having or displaying symbols, or shapes or positions of symbols, it means that they are considered as P, Q and R in the secret information input unit.

Here, the term “method for having symbols” means whether symbols are configured using a hardware module or as a result of a software module, or a result of both hardware and software modules.

Here, the term “method for displaying symbols” means whether symbols in P, Q and are displayed as a sequence corresponding to integers in one-to-one relation, displayed as a sequence intentionally extracted with restoration (“intentionally” means that the system does not extract symbols in P at random), displayed as a sequence intentionally extracted without restoration, displayed as a sequence extracted at random with restoration, displayed as a sequence extracted at random without restoration, or extracted once or repeatedly using any extraction method.

Here, the term “shape of symbol” means how a symbol is displayed in the secret information input unit. Here, the term “position of symbol” means where a symbol is displayed in the secret information input unit.

As mentioned above, if symbols in P, Q and R may be corresponding to integers from 1 to |P|+|Q|+|R| in one-to-one relation, it is the secret information input unit of the password system according to the present invention. In addition, though the number of |P|, |Q| and |R| are differently set, methods for inputting secret information using the secret information input unit are based on the spirit of the present invention.

7. Various Modifications of Action Symbol Group (P) and Non-action Symbol Group (Q)

Symbols in the secret information input unit may be dependent on the system. It means that any parts related to the symbols should not be understood to depart from the spirit of the invention though any change is made thereto. Hereinafter, various examples affecting on parts related to symbols are described.

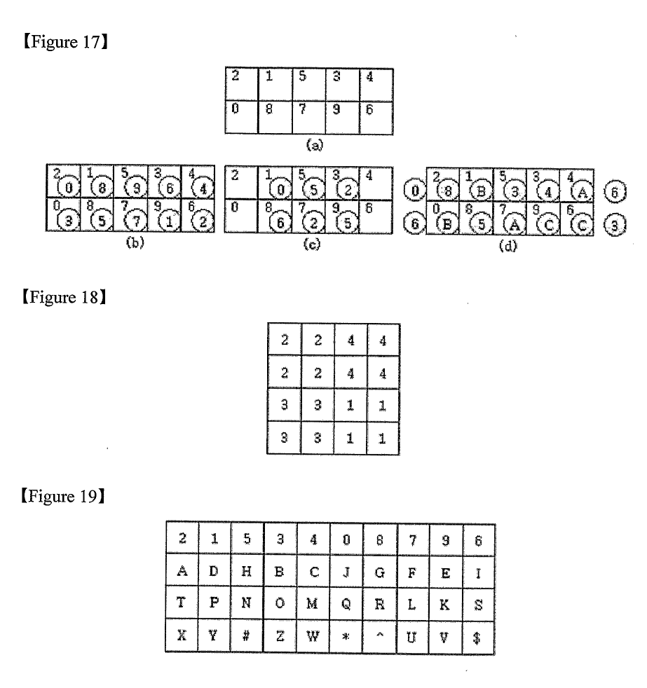

For example, it is assumed that a user conducts B to P to input X, (b), (c) and (d) of FIG. 17 represent P and Q, and (a) of FIG. 17 represents Q in (b), (c) and (d) of FIG. 14. Then, as for |Q|=10, (b) of FIG. 17 shows the case of |P|=|Q|, (c) of FIG. 17 shows the case of |P|<|Q|, and (d) of FIG. 17 shows the case of |P|>|Q|.

For example, there may be various changes in time and method of extracting symbols in P and Q, so such changes should not be interpreted to depart from the spirit of the invention. In addition, in case that a user inputs X by conducting A to P, though the system shows P that is a group of identical symbols intentionally extracted with restoration whenever Xᵢ is input, shows P that is a group of new symbols intentionally extracted with restoration when Xᵢ is input, show P that is a group of identical symbols extracted without restoration whenever Xᵢ is input, or shows P that is a group of new symbols intentionally extracted without restoration when Xᵢ is input, all of the cases are included in the spirit of the present invention that conducts A to P to input X. For example, FIG. 18 shows an example that elements in Y are intentionally extracted with restoration when Y={1, 2, 3, 4} and a user inputs X by conducting A to P.

For example, in case that B is conducted to P to input X, all symbols in Q may be different or symbols in Q may be repeatedly shown in order. In the case that C is conducted to P to input X, identical symbols extracted at random with restoration may be shown in P whenever Xᵢ is input or new symbols extracted at random with restoration may be shown in P whenever Xᵢ is input. In case that A is conducted to P to input X, identical symbols extracted at random without restoration may be shown in P whenever Xᵢ is input or new symbols extracted at random without restoration may be shown in P whenever Xᵢ is input.

For example, in case that C is conducted to P to input X, the system may force a user to accomplish the input completing step unconditionally to input X₁. Here, the term “unconditionally” implies the meaning that a user decides a symbol in Q before informing the system of the completion of input and X₁ is input in the predetermined symbol.

For example, in case that Y={y|0≦y≦0 or Capital Alphabet or #, *, ˆ, $} and a user input X by conducting C to P, the system extracts a number among 0˜9 at random without restoration to be displayed in the first row, extracts a capital Alphabet among A˜J at random without restoration to be displayed in the second row, extracts a capital Alphabet among K˜T at random without restoration to be displayed in the third row, and extracts a capital Alphabet among A˜J and #, *, ˆand S at random without restoration to be displayed in the fourth row, as shown in FIG. 19, and then allows the user to conduct C to P.

For example, in case that X is input by conducting C to P, the system may bind at least two elements in Y to be considered as one symbol and then displayed as a symbol of P, and allows the user to input X by conducting C to P. In addition, in case that X is input by conducting C to P, after guiding a user to input X₁ by conducting C to P or conducts the input completion step, the system may display symbols in P from the point of time when X₂ is input so that a user may increase symbols in P within the limited number of times.

8. Various Modifications of Control Tool Group (R)

In the password system according to the present invention, any parts related to symbols in R may be dependent on the system. Thus, it should not be understood that changing such parts departs from the scope of the password system according to the invention. Hereinafter, various examples affecting on parts related to symbols in R are described.

For example, in case that C is conducted to P, any symbol in C may be provided as a hardware module (a key on a keyboard) or a button that is a result of a software module, or as both of them. It means that a symbol pertaining to R may be provided in different ways.

For example, in case that A is conducted to P, a user may select a symbol in Q by using a mouse or may move a symbol in Q for selection. It means that a symbol pertaining to R may be provided in different ways.

For example, in case that C is conducted to P, a user may use an increment button that is a result of a software module or may fall down a scroll bar in order to conduct C to P. It means that a symbol pertaining to R may be provided in different ways.

For example, in case of conducting C to P, both of a symbol increasing symbols in P and a symbol decreasing the symbols may pertain to R, or only the symbol increasing symbols in P may exist in R. It means that a new symbol may be removed in R.

For example, in case of conducting A to P, R may be not provided with a symbol that makes P disappeared if P is set to automatically disappear after a certain time passes. It means that a new symbol may be removed in R.

For example, in case of conducting B to P, if P automatically moves, R may not have a symbol for moving P. It means that a new symbol may be removed in R.

For example, in case of conducting C to P, R may be provided with a symbol that increases values of symbols in P by 2 at the same time. It means that a new symbol may be added to R.

For example, in case of conducting B to P, P may be a cursor, or a cursor may be separately provided in addition to P. It means that a new symbol may be added to R.

For example, in case of conducting A to P, it is possible to set p to be appeared when one symbol in R is pressed and to be disappeared if the symbol is released. It means that one symbol in R may have two or more functions.

9. Selective Display of Symbol

In the information inputting method of the present invention, it takes time for a user to recognize a position where Xᵢ is displayed from the symbols displayed in the secret information input unit (1≦i≦n). In addition, the time required for recognizing a position where Xᵢ is displayed is proportional to the number of symbols displayed. For example, time taken for recognizing a position of a specific symbol in state that 30 symbols are displayed is longer than time taken for recognizing a position of a specific symbol in state that 10 symbols on the average.

In using a password, there may be a case simply using combination of numbers from 0 to 9 and a case using combination of alphabets and numbers from 0 to 9. The case of using only combination of numbers as a password is found in automatic teller machines and access control systems, while the case of using combination of alphabets and numbers from 0 to 9 is found in an Internet banking system.

If all of alphabets and numbers from 0 to 9 are displayed in the secret information input unit of the password system adopting the information inputting method of the present invention, a user may feel difficulty in recognizing a specific symbol.

Thus, when a user intends to input Xᵢ, the number of symbols including Xᵢ may be set smaller than a certain number in consideration of the time taken for recognizing a position where Xᵢ is displayed (1≦i≦n). For example, if X₁X₂=a3, 10 symbols including a are displayed prior to inputting X₁, and 10 symbols including 3 are displayed prior to inputting X₂.

Such a method for selectively displaying symbols may be implemented as mentioned below. For example, it is assumes that symbols of Y is 0˜9 and a˜z. Then, the symbols of Y are grouped into 10 groups. That is to say, 0˜9 are classified into a first group, a˜j are classified into a second group, k˜t are classified into a third group, and u˜z are classified into a fourth group. Then, the system selectively displays a corresponding group according to Xᵢ to be input.

In order that the system learns and displays a group corresponding to Xᵢ prior to inputting Xᵢ, a user may inform the system of the corresponding group or the system may recognize the corresponding group by itself.

The system may recognize the group by itself in various ways. For example, group information of each Xᵢ may be stored in cookie information based on IP address of a user computer and then used by the system in case that it is based on a network. In case of a system using ID, the system may learn a password to be input on the basis of the input ID, so the system may display symbols of the corresponding group prior to inputting Xᵢ. In other case, in case that the system is already aware of a password, the system may extracts and display the required number of symbols including Xᵢ without grouping the symbols.

As mentioned above, if the number of symbols in Y is too large, the system may selectively display only symbols of the number smaller than a certain level while Xᵢ is input so as to shorten time for a user to recognize a specific symbol.

The information inputting method capable of preventing input information from exposing to observers according to the preferred embodiments of the present invention has been described above with reference to the accompanying drawings, but those skilled in the art would understand well that the above description is for the purpose of illustration only and there may be various changes and modifications within the scope of the invention.

### INDUSTRIAL APPLICABILITY

The information inputting method of the present invention described above enables input information not to be acknowledged to observers though the information inputting procedure is observed by other persons. The information inputting method of the present invention may be applied to any kind of information device equipped with a user input means, for example personal computer systems, personal information terminals, cellular phones, access control systems, automatic teller machines, user authentication systems and door-lock systems (here, the information device includes all kinds of equipments and systems that receive information from users and processes the information). Though such an information device is operated independently or in connection with a network, the information inputting method of the present invention may be implemented identically or sufficiently modified on the level of those skilled in the art.

In addition, the user interface provided to such an information device to receive information from users may include electronic/mechanical information input mechanism, and such mechanism may be different depending on characteristics of equipments or systems adopting the information inputting method of the present invention. However, it is just a common modification originated from features of the system on the level of those skilled in the art, so those skilled in the art would understand well such modification is included in the spirit of the invention.

1. An information inputting method for inputting information (X; X=X₁X₂ . . . Xₙ, X₁εY (1≦i≦n)) by using an information device equipped with an information input unit, comprising:
providing an action symbol group, a non-action symbol group and a control tool group to the information input unit; and
matching a specific symbol (decided by a user) in the action symbol group with a unit input information (Xᵢ) by taking a movement operation to the action symbol group using the control tool group by the user.

2. The information inputting method according to claim 1, further comprising:
informing that the unit input information (Xᵢ) is completely input by using the control tool group.

3. The information inputting method according to claim 1,
wherein the user matches the specific symbol (decided by the user) with a predetermined symbol previously defined in the non-action symbol group when a final unit input information (Xₙ) is input.

4. An information inputting method for inputting information (X; X=X₁X₂ . . . Xₙ, XᵢεY (1≦i≦n)) by using an information device equipped with an information input unit, comprising:
providing an action symbol group, a non-action symbol group and a control tool group to the information input unit;
displaying symbols in the action symbol group;
conducting an operation for disappearing the symbols displayed in the action symbol group; and
selecting a symbol of the non-action symbol group that is corresponding to a position where a system corresponding to the unit input information (Xᵢ) among the symbols displayed in the action symbol group.

5. The information inputting method according to claim 4,
wherein the operation for disappearing the symbols displayed in the action symbol group is automatically conducted a predetermined time after the symbols are displayed.

6. The information inputting method according to claim 4,
wherein the operation for disappearing the symbols displayed in the action symbol group is selectively conducted on the receipt of instruction from the user using the control tool group.

7. The information inputting method according to claim 4,
wherein, in case that the user selects a symbol in the non-action symbol group corresponding to a position where (Xᵢ) is displayed in order to input a unit input information (Xᵢ), symbols of the action symbol group including unit input information (Xᵢ₊₁, 1≦i≦n−1) are displayed in other regions except the position where Xᵢ is displayed, and
wherein, in case that the selection of the user is released, the operation for disappearing the symbols displayed in the action symbol group is conducted.

8. An information inputting method for inputting information (X; X=X₁X₂ . . . X₁, XᵢεY (1≦i≦n)) by using an information device equipped with an information input unit, comprising:
providing an action symbol group, a non-action symbol group and a control tool group to the information input unit; and
a user increasing (or, decreasing) values of symbols displayed in the action symbol group by using the control tool group so that a value of a group in the action symbol group corresponding to a specific symbol (decided by the user) in the non-action symbol group is coincided with a value of a symbol corresponding to a unit input information (Xᵢ).

9. The information inputting method according to claim 8, further comprising:
informing with the use of the control tool group that the unit input information (Xᵢ) is completely input.

10. The information inputting method according to claim 8,
wherein, in the step of inputting a final unit input information (Xₙ), the user makes the symbol of the action symbol group corresponding to the specific symbol (decided by the user) in the non-action symbol group be a value of a predetermined value symbol.

11. The information inputting method according to claim 8,
wherein, in the step of increasing (or, decreasing) values of the symbols displayed in the action symbol group, increment amounts of the symbols in the action symbol group are all identical to each other, or at least one symbol has a different increment (or, decrement) amount.
